(19) United States
(12) Patent Application Publication
(10) Pub. No.: US 2022/0330422 A1
(43) Pub. Date: Oct. 13, 2022

(54) SYSTEM FOR DETECTING ACCESS TO A PRE-DEFINED AREA ON A PRINTED CIRCUIT BOARD

(71) Applicant: THALES DIS CPL USA, INC, Belcamp, MD (US)

(72) Inventor: Stephane LEMIRE, Stittsville (CA)

(21) Appl. No.: 17/226,649

(22) Filed: Apr. 9, 2021

(51) Int. Cl. H05K 1/02; G01R 31/3185

(52) U.S. Cl. CPC H05K 1/0275; G01R 31/318538; H05K 2201/10151; H05K 2201/0108

(57) ABSTRACT

The present invention provides a system for detecting access to a pre-defined area on a Printed Circuit Board, wherein the system comprises:
the Printed Circuit Board comprising, on at least one of its external surfaces, at least one pre-defined area comprising electrical components,
a potting material arranged over at least the pre-defined area, wherein the potting material comprises a first layer of transparent material configured to allow light to pass through, and a second layer of opaque material arranged so that completely blocks light towards the first layer, wherein the first layer is arranged between the Printed Circuit Board and the second layer and extends at least over the pre-defined area, and
at least one photo-sensor arranged within the first layer of transparent material and configured to generate a tamper signal upon detection of light in the first layer.

### TECHNICAL FIELD

The present invention relates to anti-tampering techniques for improving security in electronics and, particularly, it relates to a system for preventing intrusion or unauthorized access to Joint Test Action Group (“JTAG”) signals on Printed Circuit Boards (“PCB”).

More particularly, the present invention is of special interest in Hardware Security Modules (“HSM”) to prevent an intruder from accessing PCB secure areas and thus be able to probe or use critical JTAG signals.

### BACKGROUND OF THE INVENTION

The level of physical security required in cryptography products continues to increase and, therefore, meeting the level of security requirements is never fully satisfied rendering a continuous need for improvement. The security requirements may include being able to electronically detect whenever unauthorized access occurs to protected cryptography modules and other electronic components.

An example of these cryptography products are HSMs, that is, dedicated crypto processors specifically designed for the protection of the crypto key lifecycle. HSM protects cryptographic infrastructure by securely managing, processing, and storing cryptographic keys inside a hardened, tamper-resistant device. Therefore, strong software-based access management protocols must be deployed to restrict and secure the access by authorized users and prevent intrusion from unauthorized users.

Accordingly, on the hardware side, the same level of security must be achieved.

As most of electronic components, cryptography products are provided with a single layer and/or a multilayer PCB(s) that mechanically supports and electrically connects electrical or electronic components using conductive tracks, pads, vias and other features etched from one or more sheet layers of copper laminated onto and/or between sheet layers of a non-conductive substrate. These electronic components are typically soldered onto the PCB to both electrically connect and mechanically fasten them to it.

Mostly on PCBs for cryptography products, there are specific areas enclosing one or more components that contain sensitive information and/or PCB pads, traces or vias of sensitive signals that need to be thoroughly protected against intrusion.

As an example of this, PCBs are typically equipped with pads for JTAG connectors. These JTAG connectors are formed by a plurality of pins configured to connect to an on-chip Test Access Port (TAP) that, if installed, implements stateful protocols accessing a set of test registers. In other words, JTAG embodies a standardized debug port for verifying designs and testing PCBs after manufacture.

Normally, JTAG connectors are not populated on a manufactured product but the dedicated PCB pads are indeed present. By accessing JTAG pads, for instance, an attacker could remotely control the microprocessor execution and dumping memory contents.

Various protection schemes have been proposed. For instance, by covering the entire cryptographic module with a potting compound the latter provides protection to the underlying circuitry.

In addition, a metal cover in turn often covers the potting compound. Attempts to remove this metal cover by prying will result in a physical damage to the underlying potting compound, with the risk of rendering the cryptographic module circuitry inoperable, due to its adhesion to the potting material.

As this potting compound is usually made of epoxy, the curing reduces the potting compound thickness so that the JTAG connector's PCB pads are not that far away below and could be accessed if the operator (or intruder) knows exactly where they are located. As mentioned, if the JTAG connector's PCB pads provide access to the circuitry, this allows the intruder to access the device's internally stored content.

Recent developments have proposed using a stack-up of PCBs, one on top of each other, to completely enclose the secure area of the electronic circuitry, but the external PCBs still have a need for further protection.

### SUMMARY OF THE INVENTION

The present invention provides a solution for the aforementioned problems by a system for detecting access to a pre-defined area on a Printed Circuit Board according to claim 1, and a method for producing such a system according to claim 15. In dependent claims, preferred embodiments of the invention are defined.

In a first inventive aspect, the invention provides a system for detecting access to a pre-defined area on a Printed Circuit Board, wherein the system comprises:
the Printed Circuit Board comprising, on at least one of its external surfaces, at least one pre-defined area comprising electrical components,
a potting material arranged over at least the pre-defined area, wherein the potting material comprises a first layer of transparent material configured to allow light to pass through, and a second layer of opaque material arranged so that completely blocks light towards the first layer, wherein the first layer is arranged between the Printed Circuit Board and the second layer and extends at least over the pre-defined area, and
at least one photo-sensor arranged within the first layer of transparent material and configured to generate a tamper signal upon detection of light in the first layer.

Throughout this entire document, a “potting material” should be understood as a material or compound resting onto at least one pre-defined area of the Printed Circuit Board thus enclosing at least both the electrical components to be protected and the at least one photo-sensor. Preferably, this potting material bond with the PCB external surface and fills any gap between the electrical components.

In a particular embodiment, the electrical components of the pre-defined area are at least one of the followings: a component containing sensitive information, a pad, a trace, or a via of a sensitive signal. In a preferred embodiment, the electrical components are dedicated pads for Joint Test Action Group, JTAG, connectors or pins.

This photo-sensor (also known as “light sensor”) is a well-known photoelectric device able to convert detected light energy (i.e., photons) at a particular wavelength or range of wavelengths (so-called “spectrum”) into electrical energy (i.e., electrons). The photo-sensor may be a photoresistor, a photodiode, a phototransistor, or a combination thereof.

According to the invention, the potting material is arranged over at least the pre-defined area, and comprises a first (lower) layer of transparent material and a second (upper) layer of opaque material. The first layer is disposed in direct contact, and preferably bonded to, the pre-defined area of the PCB.

This first layer is configured to allow light at a specific wavelength (or range of wavelengths) to pass through, this wavelength or wavelengths matching with the light detectable by the photo-sensor for generating the tamper signal.

In this way, both the photo-sensor(s) and the electrical component(s) intended to be protected (i.e., arranged within the pre-defined area) are first enclosed by the transparent material of the first layer and subsequently covered by the second layer of opaque material completely blocking the light wavelength(s) at which the first layer is transparent.

Advantageously, this system impedes the intruder from accessing these protected components of the PCB without detection, as the photo-sensor will detect light as soon as the opaque material of the second layer has been breached. This breach in the second layer allows light to pass through the first layer reaching the photo-sensor which will generate the tamper signal in response. Accordingly, the circuitry will respond to this event as needed, for instance, erasing the sensible information from the components (e.g., memories, processors, etc.) allocated within the pre-defined area; or by disabling signals therefrom.

As mentioned, in a preferred embodiment, the material of the first layer is transparent to at least visible light, and at least one photo-sensor is configured to react upon detection of at least visible light. Preferably, the system only comprises a single photo-sensor is configured to react upon detection of visible light.

Alternatively or additionally, in a particular embodiment, the material of the first layer is transparent to a particular wavelength(s) light (different from the visible spectrum), for instance transparent to infrared light. Accordingly, at least one photo-sensor is configured to react upon detection of this particular wavelength(s) light.

Therefore, one or more photo-sensors can be used, and each of these photo-sensors can detect light at one or multiple (spectrum) wavelengths for generating the tamper signal. The system may also provide either a single photo-sensor that can detect a wide spectrum of light wavelengths, or multiple photo-sensors each able to detect light wavelength(s) at narrow (or single) spectrums.

In a particular embodiment, the first layer is made of transparent epoxy, and the second layer is made of an opaque epoxy. The first and/or second layer made of epoxy can be, optionally, thermally conductive.

Alternatively, in a particular embodiment, the second layer is either an opaque adhesive film or an opaque film glued on top of the first layer.

In a particular embodiment, the system further comprises a tamper circuitry connected to the at least one photo-sensor and configured to perform anti-tampering operation in response to receiving the tamper signal.

When the second layer is breached, light is able to go through it allowing the light sensor to detect it, which in consequence generates an active signal for as long as light is detected and where that signal is subsequently considered a tamper signal.

This tamper signal can be connected to an input of a Security manager device that contains keys that are used to encrypt information inside the cryptographic module. When the input is triggered by an active tamper signal, this sets an internal flag and also erases the configured associated internal sensitive content.

Alternatively or additionally, the tamper signal can also be connected to an input of a CPU (e.g. processor) that will react according to its programming for that event, which will set-up a flag and erase sensitive content like keys.

Therefore, the tamper circuitry may be part of the Security manager device or part of the CPU or processor.

In a particular embodiment, the system further comprises a backed-up battery configured to supply the tamper circuitry.

Advantageously, the system is able to detect an intruder even if it is powered off. Advantageously, in this situation, the dedicated backed-up battery will supply the tamper circuitry.

In a particular embodiment, the system further comprises an overlying lid sensor comprising a plurality of conductive lines conforming three-dimensional characteristics, wherein these conductive lines are electrically connected to the tamper circuitry for sending a tamper signal based on an open circuit or short between conductive lines.

The width and/or thickness of the conductive lines and/or spacing between adjacent ones provide the localized three-dimensional characteristics that the conductive lines form.

Advantageously, the resulting structural randomization of the conductive lines substantially increases the likelihood that conductive lines become broken or short during any attempt to reach the underlying circuit of the pre-defined area of the PCB.

In addition, the structural randomization increases the difficulty presented to any attempt to remotely sense and map locations of the electrical components of the pre-defined area for instance, the JTAG connectors' PCB pads.

In a preferred embodiment, the overlying lid sensor further comprises a substrate supporting the conductive lines that extend across at least a major portion of the surface of substrate facing the second layer, and wherein the overlying lid sensor further comprises drill plates.

Throughout this document, “drill plates” will be understood as two or more layers of isolated conductive material on top of each other, being separated by a thin layer of an insulating material or substrate. The purpose of such drill plates is that when being drilled through, that some material from these conductive layers will touch each other creating an electrical short between them, which is detectable by electronic circuitry as their default state is being an open circuit.

Thus, the overlying lid sensor acts as a flexible multi-layered film with the conductive lines in form of serpentines, for instance, and different drill plates made of deposited conductive ink on different layers all glued together on top of each other. These different layers are connected together and the resulting signals are in turn connected to the PCB, for instance by soldering to dedicated PCB pads.

In a particular embodiment, the overlying lid sensor extends substantially over the entire pre-defined area within the first layer, and the at least one photo-sensor is arranged closer to the second layer.

In this way, advantageously, the protection of the underlying circuit is improved.

In a preferred embodiment, the at least one photo-sensor is arranged over the overlying lid sensor closer to the second layer. Alternatively or additionally, at least one photo-sensor can be arranged beside the overlying lid sensor.

In a particular embodiment, the system further comprises a fencing element around the periphery of the pre-defined area for holding at least the first layer of transparent material.

The fencing element holding the transparent material of the first layer eases manufacturing since it can be assured that the transparent layer correctly encloses both the pre-defined area (impregnating all the electrical components thereon) and the photo-sensor(s). In other words, it assures that the thickness of the first layer is adequate to the elements embedded. Thus, if light comes from any part of the interface surface between the first and second layer, the photo-sensor will detect it.

In addition, it allows dispensing the potting material in a two-step process enabling control of the respective thicknesses of the first and second layers.

Furthermore, the use of the fencing elements allows different shapes such as rectangular, cylindrical, polyhedron, etc. thus not being limited to drop-like or bubble-like shapes for the first layer as the ones typically achieved in the absence of this fencing element. Advantageously, the photo-sensor can be arranged closer to the periphery of the pre-defined area.

The fencing element or a sufficient part of it can be opaque to prevent light from entering the first layer by its sides. In a preferred embodiment, the fencing element is made of a non-conductive material, which thickness and height has a minimum value to create a sufficiently thick transparent first layer.

In a preferred embodiment, the fencing element comprises an underlying adhesive surface, through the use of double sided tape for example, to prevent the liquid transparent material to leak underneath the fencing element, that is, to leak beyond its perimeter.

In a particular embodiment, the system further comprises a third layer of opaque material blocking the same or different wavelength light than the second layer, wherein this third layer is arranged between the first and second layers.

In this way, the surface of the first transparent layer is covered by an interface material before the second opaque layer is added above it. In addition, in case the material of the first and second layers is not the same, this third layer can improve adhesion between them.

In a particular embodiment, the third layer is an adhesive film and/or aluminum foil.

In a second inventive aspect, the invention provides a method for producing a system according to any of the embodiments of the first inventive aspect, wherein the method comprises the steps of:
i. providing the Printed Circuit Board comprising, on at least one of its external surfaces, at least one pre-defined area comprising electrical components;
ii. providing the at least one photo-sensor within the periphery of the at least one pre-defined area, and installing the photo-sensor to generate a tamper signal upon detection of light;
iii. arranging over the at least one pre-defined area a first layer of transparent material covering the at least one photo-sensor electrical components; and
iv. arranging on top of the first layer of transparent material a second layer of opaque material in such a way that the second layer completely blocks light towards the first layer.

In a particular embodiment, the method further comprises before step ii), the step of providing an overlying lid sensor over at least part of one pre-defined area, wherein the overlying lid sensor comprises a plurality of conductive lines conforming three-dimensional characteristics, and the conductive lines are electrically connected to a tamper circuitry for sending a tamper signal based on an open circuit or short between conductive lines.

In this embodiment, the at least one photo-sensor is arranged over the overlying lid sensor closer to the second layer.

Alternatively or additionally, at least one photo-sensor can be also arranged beside the overlying lid sensor.

In a particular embodiment, the method further comprises before step iv), the step of providing a third layer of opaque material blocking the same or different wavelength light than the second layer, this third layer being arranged between the first layer of transparent material and the second layer.

In a third inventive aspect, the invention provides a method for detecting access to a pre-defined area on a printed circuit board, wherein the method comprises the steps of:
i. providing a system according to any of the embodiments of the first inventive aspect;
ii. detecting, by the at least one photo-sensor, light in the first layer; and
iii. generating, by the at least one photo-sensor, a tamper signal to trigger an anti-tampering operation.

All the features described in this specification (including the claims, description and drawings) and/or all the steps of the described method can be combined in any combination, with the exception of combinations of such mutually exclusive features and/or steps.

### BRIEF DESCRIPTION OF THE DRAWINGS

These and other characteristics and advantages of the invention will become clearly understood in view of the detailed description of the invention which becomes apparent from a preferred embodiment of the invention, given just as an example and not being limited thereto, with reference to the drawings.

FIG. 1 This figure shows a schematic cross-sectional view of a first embodiment of the system according to the invention.

FIG. 2 This figure shows a schematic cross-sectional view of a second embodiment of the system according to the invention.

FIG. 3 This figure shows a schematic cross-sectional view of a third embodiment of the system according to the invention.

FIGS. 4a,4b These figures show a schematic view of a drill plates and serpentines of the overlying lid sensor according to the invention.

FIG. 5 This figure shows a schematic workflow of a method for detecting access to a pre-defined area on a printed circuit board according to the invention.

### DETAILED DESCRIPTION OF THE INVENTION

As it will be appreciated by one skilled in the art, aspects of the present invention may be embodied as a system (10) or a method.

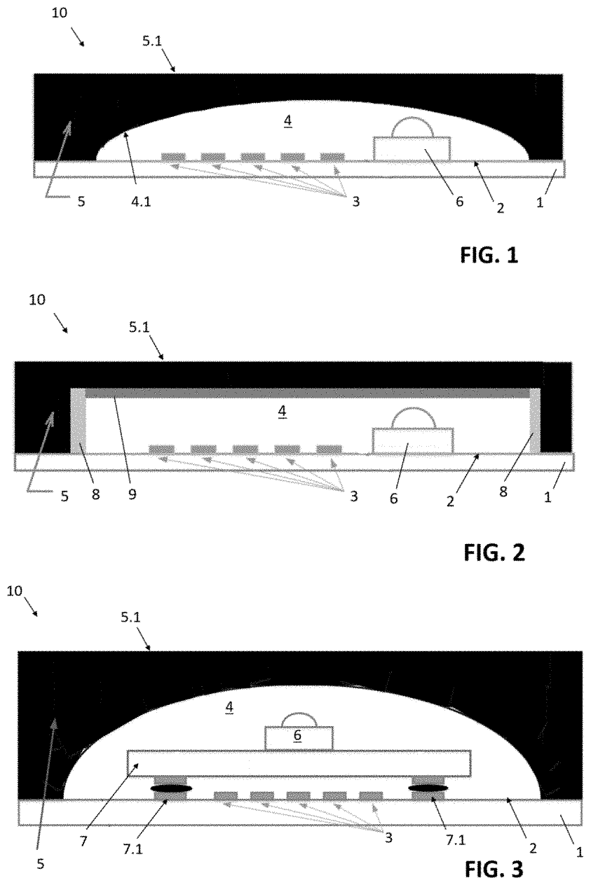

FIG. 1 depicts a schematic system (10) for detecting access or intrusion to certain electrical components (3) arranged within the periphery of a pre-defined area (2) on a Printed Circuit Board (1).

The Printed Circuit Board (1) may be a single layer or multi-layered PBC so that the invention protects the external surfaces of the PBC which are the ones facing outside after assemble. Intruders may try to gain access to these electrical components (3) arranged on the pre-defined area (2) that are now intended to be protected.

In the following, it will be assumed for exemplary purposes that the electrical components (3) are dedicated pads for JTAG pins or connectors. By accessing JTAG pads, for instance, an attacker could remotely control the microprocessor execution and dumping memory contents.

Nevertheless, the skilled person will understand that other component(s) containing sensitive information, pad(s), trace(s) (or track(s)), or via(s) of sensitive signal can be protected as well.

Referring back to FIG. 1, it is shown a potting material split into two different layers: a bottommost first layer (4) of transparent material and an uppermost second layer (5) of opaque material.

The first layer (4) is disposed in direct contact with, and bonded to, the pre-defined area (2) of the PCB (1). The external surface of the PCB (1) may comprise a solder mask.

As it can be derived also from FIG. 1, the first layer (4) encloses a photo-sensor (6) and the JTAG connectors' PCB pads (3). Although only one photo-sensor (6) is depicted, multiple ones can be envisaged within the present invention.

The first layer allows light at specific wavelength(s) to pass through, this wavelength or spectrum of wavelengths matching with the light detectable by the photo-sensor(s) (6) for generating a tamper signal.

In other words, if any light (for which the first layer is transparent to) enters from any point of the boundary (4.1) of the first layer (4), it will reach the photo-sensor (6) and trigger the tamper signal. Advantageously, the photo-sensor will issue an alert regardless of the incoming direction of the light.

The second layer (5) of opaque material is arranged so that it completely blocks light towards the first layer (4). Therefore, the opaque layer is configured to block at least the wavelength(s) at which the first layer material exhibits transparency. For instance, these two layers (4, 5) can be made of epoxy.

For exemplary purposes, it will be assumed that the first layer is transparent to visible light, which is detectable by the photo-sensor, while the second layer is opaque to this light.

When an intruder attempts to access the JTAG connectors' PCB pads, he or she starts scratching or removing part of the outermost portion (5.1) of the second layer (5) up to produce a breach (i.e., a point where light can enter the first layer (4)). The, this light goes through the transparent material and is detected by the photo-sensor, therefore detecting the tampering event and accordingly issuing a tampering signal to allow an electronic circuitry to respond accordingly (i.e., through an anti-tampering operation), which in some cases might consist on erasing the sensitive information contained inside the sensitive PCB area.

The system (10) may also comprise a battery backed-up tamper circuitry (not shown) connected to the at least one photo-sensor (6) and configured to perform the anti-tampering operation in response to receiving the tamper signal.

Although the boundary surface is shown as a bubble in FIG. 1, it is not limited to this specific shape as will be seen hereinafter. Other shapes can be flat, convex or concave.

In a preferred embodiment, the first (4) and second (5) layers are made from epoxy. Then, in an example, when the first layer (4) of epoxy has cured, a chemical bond to it is not possible and, instead, bonding should be promoted by mechanical means. For instance, this mechanical bonding can be achieved by lightly sanding the boundary (4.1) or outer surface of the first layer (4) before applying or depositing the second layer (5) of epoxy.

In another example, when the first layer (4) of epoxy is not completely cured and remains tacky, a second pour of epoxy can be made for the second layer (5). Advantageously, adding the second layer (5) at this stage allows avoiding any surface preparation. Nevertheless, as mentioned, if the cure goes beyond the tacky stage, then the epoxy for the first layer (4) is let to finish the curing cycle and, afterward, a sand dull and cleaning of the surface is performed before applying the next layer.

Advantageously, epoxy continues the curing cycle even if sealed, as it is a chemical reaction where no air is needed.

The second layer (5) may extend beyond the pre-defined area (2) over other areas of the PCB (1) for enclosing other electrical components, pads, traces, vias, etc. of the PCB outside this area (2).

FIG. 2 depicts a variant of the embodiment of FIG. 1, where the system (10) further comprising a fencing element (8) around the periphery of the pre-defined area (2) for holding at least the first layer (4) of transparent material.

This fencing element (8) shapes the contour of the first layer (4) and may closely match the shape of the pre-defined area (2) of the PCB intended to be protected in order to save transparent material.

After deposition of the first layer (4), the second layer (5) can be applied both over the boundary (4.1) of the first layer (4) and the surroundings.

In this way, production lead time is increased because the pre-defined area(s) (2) on the PCB can be filled in advance and then the remainder PCB areas can be covered by the material of the second layer (5) up to a height that covers the first layer (4) so as to completely block light thereinto.

In order to assure, for instance, that light is completely blocked, the system may further comprises a third layer (9) of opaque material blocking the same or different wavelength light than the second layer (5).

As it can be seen, this third layer (9) is arranged between part or the entire interface between the first (4) and second (5) layers. For instance, in FIG. 1, the third layer (9) complements the fencing element (8) in order to surround the first layer (4).

In other embodiments (not shown), the third layer (9) can be embodied as a cap-shaped element comprising a lateral wall matching the contour of the fencing element (8) and a built-in lid to cover it.

The third layer (9) may also promote adhesion between the first (4) and second (5) layers.

As known, the first epoxy layer (4) should cure or be cured enough (i.e., substantially retaining its shape and tacky) before applying the second layer (5) on top of it. In this case, the interface or boundary (4.1) between them is a clean and fully defined surface.

Otherwise, as mentioned, if the first epoxy layer (4) is not let to sufficiently or fully cure before applying the second layer (5) on top of it, this entails that the second layer (5) may blend into the boundary (4.1) of the first layer (4). In this case, a third layer (9) would be required to achieve a defined interface.

This third layer can be made of any compatible material with, for instance, epoxy material allowing the first (4) and second (5) layers to cure at the same time. Advantageously, this reduces manufacturing lead-time by a single cure time, which might be longer as a thicker layer is to cure. As an example, the third layer (9) may be an adhesive film.

Collaterally, in presence of the third layer (9), the second layer (5) would not need to be as thick as before, but just sufficiently thick for blocking at least the wavelengths to which the light sensor is sensitive to. In further developments of the invention, the third layer can be also transparent.

For instance, even if the first layer (4) of epoxy has partially (i.e., still tacky) or completely cured, a piece of aluminum, such as aluminium foil, or any other opaque material that epoxy adheres to, can be used as the third layer (9) and can immediately or later be covered by the second layer (5) of epoxy. In further embodiments, an adhesive helps to bond the aluminium foil to the cured first layer, or the aluminium foil may already comprise an adhesive surface.

Therefore, in a particular embodiment, the third layer (9) is an adhesive aluminium foil.

FIG. 3 depicts a further embodiment of the system (10). For exemplary purposes, it is shown as a variant of FIG. 1 but it can also inherits the features and advantages of the system (10) according to FIG. 2.

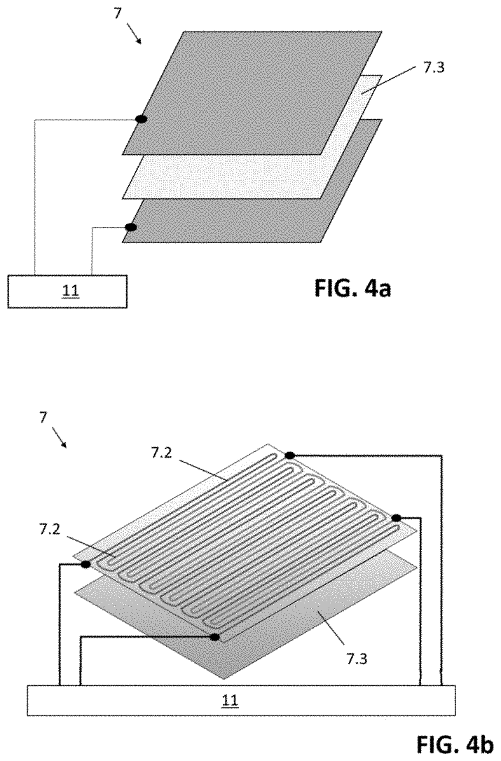

As it can be seen, the system further comprises an overlying lid sensor (7) comprising a plurality of conductive lines (7.2) that conforms three-dimensional characteristics. These conductive lines (7.2) are electrically connected to the tamper circuitry (11) in order to send a tamper signal in response to an open circuit or short between conductive lines (7.2) caused by the tools of an intruder (see FIGS. 4a and 4b).

The overlying lid sensor (7) may further comprise a substrate (7.3) supporting the conductive lines (7.2) that extend across at least a major portion of the surface of substrate facing the second layer. In this embodiment, the overlying lid sensor (7) further comprises drill plates.

This overlying lid sensor (7) can be embodied as a secondary intrusion detection PCB, soldered (e.g., by soldered paste) directly to the main PCB through dedicated connections pads (7.1) to it. This secondary PCB is located above the sensitive signals like the JTAG connector's PCB pads and preferably covers the whole pre-defined area.

Thanks to this arrangement, it makes any attempt to access these JTAG connector's PCB pads to first go through this secondary PCB. As it comprises layer(s) of randomized or serpentine conductive lines (7.2) with drill plate(s) (7.2), if the lines become an open circuit or if there is a short between any combinations of lines and/or drill plate(s), this causes a tamper signal to the battery backed-up tamper circuitry that will respond to the event.

Through the entire document, “drill plates” are understood as two or more layers of conductive material layered on top of each other that are separated by a thin layer of an insulating material or substrate (7.3). The conductive layers may be either continuous conductive surfaces, made of conductive lines (7.2), or a combination thereof. Drill plates can be seen from FIG. 4a.

The purpose of such drill plates is that due to their closeness, when being drilled through, that some of the material removed by the drill bit from these conductive layers will touch each other creating an electrical short between both, which is detectable by electronic circuitry (such as tamper circuitry (11)) as their default state is being an open circuit.

Conductive lines (7.2) in form of serpentines can be seen in FIG. 4b. Conductive serpentines are conductive traces going around the surface of an insulating layer or substrate (7.3) from one point to the other, usually in a non-linear fashion.

The purpose of such serpentine traces is that when drilled through or when material is removed that it will break connectivity along the trace, creating an open that is detectable by electronic circuitry as its default state is being a short between both extremities of the serpentine. In addition, the removed material can also create a short with another serpentine or even a drill plate that are isolated from it, which conditions are also detectable by electronic circuitry (such as tamper circuitry (11)). As mentioned, the electronic circuitry or tamper circuitry (11) can optionally also detect any combinations of shorts between various serpentines and/or drill plate layers, so that two or more simultaneous tamper conditions cannot cancel each other.

As it can be appreciated from FIG. 3, the overlying lid sensor (7) extends substantially over the entire pre-defined area within the first layer (4), and the photo-sensor (6) is arranged closer to the second layer (5).

In particular, the photo-sensor (6) is centered on top of the secondary PCB (7) and both are covered by a sufficiently thick layer of transparent material which is shown as a bubble in the figure, but it is not limited to this specific shape as explained above.

This makes it even more difficult for the intruder to access the pre-defined area (2) of the PCB (1) without detection, as the photo-sensor (6) will detect light as soon as the opaque material layer above it has been breached. As soon as the optical sensor detects light, it generates a tamper signal to the battery backed-up tamper circuitry that will respond to the event. Even if the intruder is able to use non-detectable light wavelengths, he still has to go through the secondary PCB that will issue the tamper event.

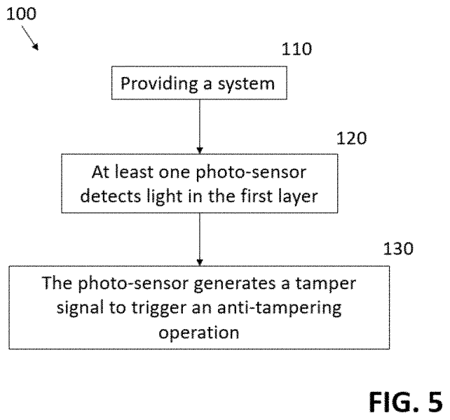

FIG. 5 depicts a method (100) for detecting access to a pre-defined area on a printed circuit board, wherein the method comprises the steps of:
iv. providing (110) a system according to any of the embodiments shown in FIGS. 1 to 3;
   detecting (120), by at least one photo-sensor, light in the first layer; and
   generating (130), by the at least one photo-sensor, a tamper signal to trigger an anti-tampering operation.

1. A system for detecting access to a pre-defined area on a printed circuit board, wherein the system comprises:
the printed circuit board comprising, on at least one external surface of the printed circuit board, at least one pre-defined area comprising electrical components,
a potting material arranged over at least the pre-defined area, wherein the potting material comprises a first layer of transparent material configured to allow light to pass through, and a second layer of opaque material arranged so that completely blocks light towards the first layer, wherein the first layer is arranged between the printed circuit board and the second layer and extends at least over the pre-defined area, and
at least one photo-sensor arranged within the first layer of transparent material and configured to generate a tamper signal upon detection of light in the first layer.

2. The system according to claim 1, wherein the material of the first layer is transparent to at least visible light, and at least one photo-sensor is configured to react upon detection of at least visible light.

3. The system according to claim 1, wherein the material of the first layer is transparent to a particular wavelength light, preferably infrared light, and at least one photo-sensor is configured to react upon detection of this particular wavelength light.

4. The system according to claim 1, wherein the first layer is made of transparent epoxy, and/or the second layer is made of opaque epoxy that is optionally thermally conductive.

5. The system according to claim 1, further comprising a tamper circuitry connected to the at least one photo-sensor and configured to perform anti-tampering operation in response to receiving the tamper signal.

6. The system according to claim 5, further comprising a backed-up battery configured to supply the tamper circuitry.

7. The system according to claim 5, further comprising an overlying lid sensor comprising a plurality of conductive lines conforming three dimensional characteristics, wherein these conductive lines are electrically connected to the tamper circuitry for sending a tamper signal based on an open circuit or short between conductive lines.

8. The system according to claim 7, wherein the overlying lid sensor further comprises a substrate supporting the conductive lines that extend across at least a major portion of the surface of substrate facing the second layer, and wherein the overlying lid sensor further comprises drill plates.

9. The system according to claim 5, wherein the overlying lid sensor extends substantially over the entire pre-defined area within the first layer, and the at least one photo-sensor is arranged closer to the second layer.

10. The system according to claim 1, further comprising a fencing element around the periphery of the pre-defined area for holding at least the first layer of transparent material.

11. The system according to claim 1, wherein the electrical components of the pre-defined area are at least one of the followings: a component containing sensitive information, a pad, a trace, or a via of a sensitive signal.

12. The system according to claim 1, wherein the electrical components are dedicated pads for Joint Test Action Group, JTAG, pins or connectors.

13. The system according to claim, further comprising third layer of opaque material blocking the same or different wavelength light than the second layer, wherein this third layer is arranged between the first and second layers.

14. The system according to claim 13, wherein the third layer is an adhesive film and/or aluminum foil.

15. A method for detecting access to a pre-defined area on a printed circuit board, wherein the method comprises the steps of:
providing a system that comprises:
the printed circuit board comprising, on at least one external surface of the printed circuit board, at least one pre-defined area comprising electrical components,
a potting material arranged over at least the pre-defined area, wherein the potting material comprises a first layer of transparent material configured to allow light to pass through, and a second layer of opaque material arranged so that completely blocks light towards the first layer, wherein the first layer is arranged between the printed circuit board and the second layer and extends at least over the pre-defined area, and
at least one photo-sensor arranged within the first layer of transparent material and configured to generate a tamper signal upon detection of light in the first layer;
detecting, by at least one photo-sensor, light in the first layer; and
generating, by the at least one photo-sensor, a tamper signal to trigger an anti-tampering operation.
